(19) United States
(12) Patent Application Publication
(10) Pub. No.: US 2025/0286132 A1
(43) Pub. Date: Sep. 11, 2025

(54) ELECTROLYTE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Harim LEE, Yongin-si (KR); TAE HYON BAE, Yongin-si (KR); Sanghyung KIM, Yongin-si (KR); Seunghyeon SON, Yongin-si (KR); Yeji YANG, Yongin-si (KR); SUNDAE KIM, Yongin-si (KR); Sangheon LEE, Yongin-si (KR); CHEONSOO KIM, Yongin-si (KR)

(21) Appl. No.: 18/812,620

(22) Filed: Aug. 22, 2024

(30) Foreign Application Priority Data
Mar. 8, 2024 (KR) 10-2024-0033397

(51) Int. Cl. H01M 10/0567; H01M 10/0569

(52) U.S. Cl. CPC H01M 10/0567; H01M 10/0569

(57) ABSTRACT

A rechargeable lithium battery includes an electrolyte. The electrolyte may include a non-aqueous organic solvent, a lithium salt, a first compound represented by Chemical Formula 1, and a second compound represented by Chemical Formula 2.

### CROSS-REFERENCE TO RELATED APPLICATION

The present application claims priority to and the benefit of Korean Patent Application No. 10-2024-0033397, filed on Mar. 8, 2024 in the Korean Intellectual Property Office, the content of which is hereby incorporated by reference in its entirety.

### BACKGROUND

### 1. Field

Embodiments of the present disclosure described herein are related to an electrolyte for a rechargeable lithium battery and a rechargeable lithium battery including the same.

### 2. Description of the Related Art

Recently, with the rapid spread of electronic devices using batteries, such as mobile phones, laptop computers, and/or electric vehicles, there is a rapidly increasing demand or desire for rechargeable batteries with relatively high energy density and high capacity. Therefore, intensive research has been conducted to improve performance of rechargeable lithium batteries.

A rechargeable lithium battery includes a positive electrode, a negative electrode, and an electrolyte. The positive and negative electrodes (e.g., each) include an active material in which intercalation and deintercalation (e.g., of lithium ions) are possible, and generates electrical energy caused by oxidation and reduction reactions if (e.g., when) lithium ions are intercalated and deintercalated.

### SUMMARY

Aspects according to one or more embodiments are directed toward an electrolyte for a rechargeable lithium battery whose impregnation is excellent or suitable.

Aspects according to one or more embodiments are directed toward a rechargeable lithium battery including the electrolyte.

According to one or more embodiments of the present disclosure, an electrolyte for a rechargeable lithium battery may include: a non-aqueous organic solvent; a lithium salt; a first compound represented by Chemical Formula 1; and a second compound represented by Chemical Formula 2.

R^{1A}—O—R^{1B} [Chemical Formula 1]

In Chemical Formula 1, R^{1A} and R^{1B} may each independently be a substituted or unsubstituted C2 to C10 alkyl group.

In Chemical Formula 1, at least one selected from among R^{1A} and R^{1B} may be a halogenated alkyl group represented by Chemical Formula A1.

CₙH₂ₙ₊₁₋ₘXₘ [Chemical Formula A1]

In Chemical Formula A1, X may be F, Cl, Br, I, and/or a (e.g., any suitable) combination thereof, n may be an integer between 2 and 10, and m may be an integer between 2 and 2n+1.

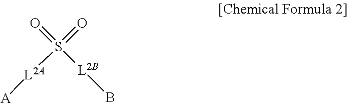

In Chemical Formula 2, L^{2A} and L^{2B} may each independently be a single bond, a substituted or unsubstituted C1 to C5 alkylene group, a substituted or unsubstituted C2 to C5 alkenylene group, a substituted or unsubstituted C2 to C5 alkynylene group, or a substituted or unsubstituted C6 to C20 arylene group.

In Chemical Formula 2, A and B may each independently be a substituted or unsubstituted C1 to C20 alkyl group, a substituted or unsubstituted C6 to C20 aryl group, or a substituted or unsubstituted C2 to C20 heteroaryl group.

In Chemical Formula 2, at least one selected from among A and B may be a group represented by Chemical Formula A2.

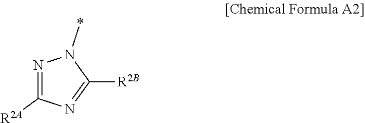

In Chemical Formula A2, R^{2A} and R^{2B} may each independently be hydrogen, halogen, a substituted or unsubstituted C1 to C10 alkyl group, or a substituted or unsubstituted C3 to C10 cycloalkyl group.

According to one or more embodiments of the present disclosure, a rechargeable lithium battery may include: a positive electrode that includes a positive electrode active material; a negative electrode that includes a negative electrode active material; and the aforementioned electrolyte for the rechargeable lithium battery.

### BRIEF DESCRIPTION OF DRAWINGS

FIG. 1 illustrates a conceptual diagram showing a rechargeable lithium battery according to one or more embodiments of the present disclosure.

FIGS. 2-5 illustrate conceptual diagrams each showing a rechargeable lithium battery according to one or more embodiments of the present disclosure.

FIG. 6 illustrates an image showing test results of impregnation of an electrolyte according to Embodiments 1-5 and Comparative Examples 1-5.

### DETAILED DESCRIPTION

In order to sufficiently understand the configuration and aspect of the present disclosure, one or more embodiments of the present disclosure will be described with reference to the accompanying drawings. It should be noted, however, that the present disclosure is not limited to the following example embodiments, and may be implemented in one or more suitable forms. Rather, the example embodiments are provided only to disclose the present disclosure and let those skilled in the art fully know the scope of the present disclosure.

In this description, it will be understood that, if (e.g., when) an element is referred to as being on another element, the element can be directly on the other element or intervening elements may be present therebetween. In the drawings, thicknesses of some components are exaggerated for effectively explaining the technical contents. Like reference numerals refer to like elements throughout, and duplicative descriptions thereof may not be provided the specification.

Unless otherwise specially noted in this description, the expression of singular form may include the expression of plural form. In addition, unless otherwise specially noted, the phrase “A or B” may indicate “A but not B”, “B but not A”, and “A and B”. The terms “comprises/includes” and/or “comprising/including” used in this description do not exclude the presence or addition of one or more other components.

As used herein, the term “combination thereof” may refer to a mixture, a stack, a composite, a copolymer, an alloy, a blend, or a reaction product.

Unless otherwise especially defined in this description, a particle diameter may be an average particle diameter. In addition, a particle diameter indicates an average particle diameter (D50) where a cumulative volume is about 50 volume % in a particle size distribution. The average particle diameter (D50) may be measured by a method suitable to those skilled in the art, for example, by a particle size analyzer, a transmission electron microscope (TEM) image, or a scanning electron microscope (SEM) image. In one or more embodiments, a dynamic light-scattering measurement device is used to perform a data analysis, the number of particles is counted for each particle size range, and then from this, an average particle diameter (D50) value may be obtained through a calculation. Dissimilarly, a laser scattering method may be utilized to measure the average particle diameter (D50). In the laser scattering method, a target particle is distributed in a distribution solvent, introduced into a laser scattering particle measurement device (e.g., MT3000 commercially available from Microtrac, Inc), irradiated with ultrasonic waves of 28 kHz at a power of 60 W, and then an average particle diameter (D50) is calculated in the 50% standard of particle diameter distribution in the measurement device.

As utilized herein, expressions such as “at least one of”, “one of”, and “of (e.g., selected from among)”, when preceding a list of elements, modify the entire list of elements and do not modify the individual elements of the list. For example, “at least one of a, b or c”, “at least one selected from among a, b and c”, and/or the like, may indicate only a, only b, only c, both (e.g., simultaneously) a and b, both (e.g., simultaneously) a and c, both (e.g., simultaneously) b and c, all of a, b, and c, or variations thereof.

The term utilized herein is intended to describe only a specific embodiment and is not intended to limit the present disclosure. As utilized herein, the singular forms “a,” “an,” and “the” are intended to include the plural forms, including “at least one,” unless the content (e.g., amount) clearly indicates otherwise. “At least one” should not be construed as being limited to the singular. As utilized herein, the term “and/or” includes any and all combinations of one or more of the associated listed items. The terms “includes,” “including,” “comprises,” and/or “comprising,” when utilized in the detailed description, specify a presence of stated features, regions, integers, steps, operations, elements, and/or components, but do not preclude the presence or addition of one or more other features, regions, integers, steps, operations, elements, components, and/or groups thereof.

Spatially relative terms such as “beneath,” “below,” “lower,” “above,” and “upper” may be utilized herein to easily describe one element or feature's relationship to another element or feature. It will be understood that the spatially relative terms are intended to encompass different orientations of a device in utilize or operation in addition to the orientation illustrated in the drawings. For example, when a device in the drawings is turned over, elements described as “below” or “beneath” other elements or features would then be “above” or “over” the other elements or features. In some embodiments, the example term “below” may encompass both (e.g., simultaneously) orientations of above and below. The device may be otherwise oriented (rotated 90 degrees or at other orientations), and the spatially relative terms utilized herein may be interpreted accordingly.

As utilized herein, the term “substantially” and similar terms are utilized as terms of approximation and not as terms of degree, and are intended to account for the inherent deviations in measured or calculated values that would be recognized by those of ordinary skill in the art. Also, the term “about” and similar terms, when utilized herein in connection with a numerical value or a numerical range, are inclusive of the stated value and a value within an acceptable range of deviation for the particular value as determined by one of ordinary skill in the art, considering the measurement in question and the error associated with measurement of the particular quantity (e.g., the limitations of the measurement system). For example, “about” may refer to within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

In this description, unless otherwise separately defined, the term “substituted” may refer to that at least one hydrogen of a substituent or a compound is substituted by deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, and/or a (e.g., any suitable) combination thereof.

For example, the term “substituted” may refer to that at least one hydrogen of a substituent or a compound is substituted by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may refer to that at least one hydrogen of a substituent or a compound is substituted by deuterium, a halogen group, a C1 to C20 alkyl group, a C6 to C30 aryl group, a C1 to C10 fluoroalkyl group, or a cyano group. In one or more embodiments, the term “substituted” may refer to that at least one hydrogen of a substituent or a compound is substituted by deuterium, a halogen group, a C1 to C5 alkyl group, a C6 to C18 aryl group, a C1 to C5 fluoroalkyl group, or a cyano group. For example, the term “substituted” may refer to that at least one hydrogen of a substituent or a compound is substituted by deuterium, a cyano group, a halogen group, a methyl group, an ethyl group, a propyl group, a butyl group, a phenyl group, a biphenyl group, a terphenyl group, a trifluomethyl group, or a naphthyl group.

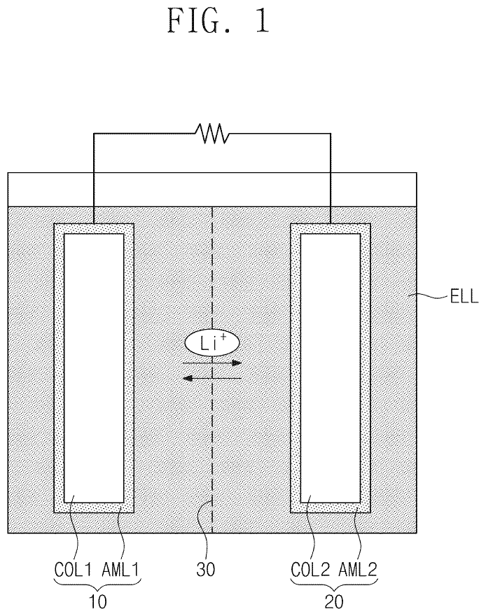

FIG. 1 illustrates a conceptual diagram showing a rechargeable lithium battery according to one or more embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced and/or apart (e.g., spaced apart or separated) from each other across the separator 30. The separator 30 may be arranged between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in and/or with the electrolyte ELL.

The electrolyte ELL may be a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material and further include a binder and/or a conductive material.

For example, the positive electrode 10 may further include an additive that can serve as a sacrificial positive electrode.

An amount of the positive electrode active material may range from about 90 wt % to about 99.5 wt % based on 100 wt % of the positive electrode active material layer AML1. Amounts of the binder and the conductive material may be about 0.5 wt % to about 5 wt % based on 100 wt % of the positive electrode active material layer AML1.

The binder may serve to improve attachment of positive electrode active material particles to each other and also to improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, and/or nylon, but the present disclosure is not limited thereto.

The conductive material may be used to provide an electrode with conductivity, and any suitable conductive material without causing chemical change of a battery may be used as the conductive material to constitute the battery. The conductive material may include, for example, a carbon-based material such as natural graphite, artificial graphite, carbon black, acetylene black, Ketjenblack, carbon fiber, carbon nano-fiber, and carbon nano-tube; a metal powder or metal fiber containing one or more of copper, nickel, aluminum, and silver; a conductive polymer such as a polyphenylene derivative; and/or a (e.g., any suitable) mixture thereof.

Aluminum (Al) may be used as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and de-intercalate lithium. For example, the positive electrode active material may include at least one kind of composite oxide including lithium and metal that is selected from among cobalt, manganese, nickel, and/or a (e.g., any suitable) combination thereof.

The composite oxide may include lithium transition metal composite oxide, for example, lithium-nickel-based oxide, lithium-cobalt-based oxide, lithium-manganese-based oxide, lithium-iron-phosphate-based compounds, cobalt-free nickel-manganese-based oxide, and/or a (e.g., any suitable) combination thereof.

For example, the positive electrode active material may include a compound represented by any one of chemical formulae LiₐA_{1-b}X_{b}O_{2-c}D_{c} (0.90≤aₛ1.8, 0≤b≤0.5, 0≤c≤0.05), LiₐMn_{2-b}X_{b}O_{4-c}D_{c} (0.90≤a≤1.8, 0≤b≤0.5, 0≤c≤0.05), LiₐNi_{1-b-c}CO_{b}X_{c}O_{2-α}D_{α} (0.90≤a≤1.8, 0≤b≤0.5, 0≤c≤0.5, 0<α<2), LiₐNi_{1-b-c}Mn_{b}X_{c}O_{2-α}D_{α} (0.90≤a≤1.8, 0≤b≤0.5, 0≤c≤0.5, 0<α<2), LiₐNi_{b}Co_{c}L¹_{d}GeO₂ (0.90·a·1.8, 0≤b≤0.9, 0≤c≤0.5, 0≤d≤0.5, 0≤e≤0.1), LiₐNiG_{b}O₂ (0.90≤a≤1.8, 0.001≤b≤0.1), LiₐCoG_{b}O₂ (0.90≤a≤1.8, 0.001≤b≤0.1), LiₐMn_{1-b}G_{b}O₂ (0.90≤a≤1.8, 0.001≤b≤0.1), LiₐMn₂G_{b}O₄ (0.90≤a≤1.8, 0.001≤b≤0.1), LiₐMn_{1-g}G_{g}PO₄ (0.90≤a≤1.8, 0≤g≤0.5), Li_{(3-f)}Fe₂(PO₄)₃ (0≤f≤2), and LiₐFePO₄ (0.90≤a≤1.8).

In the chemical formulae above, A is Ni, Co, Mn, and/or a (e.g., any suitable) combination thereof, X is Al, Ni, Co, Mn, Cr, Fe, Mg, Sr, V, a rare-earth element, and/or a (e.g., any suitable) combination thereof, D is O, F, S, P, and/or a (e.g., any suitable) combination thereof, G is Al, Cr, Mn, Fe, Mg, La, Ce, Sr, V, and/or a (e.g., any suitable) combination thereof, and L¹ is Mn, Al, and/or a (e.g., any suitable) combination thereof.

For example, the positive electrode active material may be a high nickel-based positive electrode active material having a nickel content (e.g., amount) of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % based on 100 mol % of metal devoid of lithium in the lithium transition metal composite oxide. The high nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material and may further include a binder and/or a conductive material.

For example, the negative electrode active material layer AML2 may include a negative electrode active material of about 90 wt % to about 99 wt %, a binder of about 0.5 wt % to about 5 wt %, and a conductive material of about 0 wt % to about 5 wt %.

The binder may serve to improve attachment of negative electrode active material particles to each other and also to improve attachment of the negative electrode active material to the current collector COL2. The binder may include a non-aqueous binder, an aqueous binder, a dry binder, and/or a (e.g., any suitable) combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, and/or a (e.g., any suitable) combination thereof.

The aqueous binder may include styrene-butadiene rubber, (meth)acrylated styrene-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, and/or a (e.g., any suitable) combination thereof.

When an aqueous binder is used as the negative electrode binder, a cellulose-based compound capable of providing viscosity may further be included. The cellulose-based compound may include one or more of carboxymethyl cellulose, hydroxypropylmethyl cellulose, methyl cellulose, and alkali metal salts thereof. The alkali metal may include Na, K, or Li.

The dry binder may include a fibrillizable polymer material, for example, polytetrafluoroethylene, polyvinylidene fluoride, polyvinylidene fluoride-hexafluoropropylene copolymer, polyethylene oxide, and/or a (e.g., any suitable) combination thereof.

The conductive material may be used to provide an electrode with conductivity, and any suitable conductive material without causing chemical change of a battery may be used as the conductive material to constitute the battery. For example, the conductive material may include a carbon-based material such as natural graphite, artificial graphite, carbon black, acetylene black, Ketjenblack, carbon fiber, carbon nano-fiber, and carbon nano-tube; a metal powder or metal fiber including one or more of copper, nickel, aluminum, and silver; a conductive polymer such as a polyphenylene derivative; and/or a (e.g., any suitable) mixture thereof.

The current collector COL2 may include a copper foil, a nickel foil, a stainless-steel foil, a titanium foil, a nickel foam, a copper foam, a polymer substrate coated with a conductive metal, and/or a (e.g., any suitable) combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, crystalline carbon, amorphous carbon, and/or a (e.g., any suitable) combination thereof. For example, the crystalline carbon may include graphite such as non-shaped, sheet-shaped, flake-shaped, sphere-shaped, or fiber-shaped natural or artificial graphite, and the amorphous carbon may include soft carbon, hard carbon, mesophase pitch carbon, or calcined coke.

The lithium metal alloy may include an alloy of lithium and metal that is selected from among Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include silicon, silicon-carbon composite, SiOx (0<x≤2), Si-Q alloy (where Q is alkali metal, alkaline earth metal, Group 13 element, Group 14 element (except for Si), Group 15 element, Group 16 element, transition metal, a rare-earth element, and/or a (e.g., any suitable) combination thereof), and/or a (e.g., any suitable) combination thereof. The Sn-based negative electrode active material may include Sn, SnOx (0<x≤2), e.g., SnO₂, a Sn-based alloy, a combination thereof.

The silicon-carbon composite may be a composite of silicon and amorphous carbon. According to one or more embodiments, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) positioned on a surface of the secondary particle. The amorphous carbon may also be positioned between the primary silicon particles, and for example, the primary silicon particles may be coated with the amorphous carbon. The secondary particles may be present as dispersed in an amorphous carbon matrix.

The silicon-carbon composite may further include crystalline carbon. For example, the silicon-carbon composite may include a core including crystalline carbon and silicon particles and may also include an amorphous carbon coating layer positioned on a surface of the core.

The Si-based negative electrode active material or the Sn-based negative electrode active material may be used in combination with a carbon-based negative electrode active material.

### Separator 30

Based on type or kind of the rechargeable lithium battery, the separator 30 may be present between positive electrode 10 and the negative electrode 20. The separator 30 may include one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one or opposite surfaces of the porous substrate The coating layer may include an organic material, an inorganic material, and/or a (e.g., any suitable) combination thereof.

The porous substrate may be a polymer layer including at least one selected from among polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, and polytetrafluoroethylene (e.g., Teflon), or may be a copolymer or mixture including two or more of the materials mentioned above.

The organic material may include a polyvinylidenefluoride-based copolymer or a (meth)acrylic copolymer.

The inorganic material may include an inorganic particle selected from among Al₂O₃, SiO₂, TiO₂, SnO₂, Ce₀₂, MgO, NiO, CaO, GaO, ZnO, ZrO₂, Y₂O₃, SrTiO₃, BaTiO₃, Mg(OH)₂, Boehmite, and/or a (e.g., any suitable) combination thereof, but the present disclosure is not limited thereto.

The organic material and the inorganic material may be present as mixed in one coating layer or may be present as a stack of a coating layer including the organic material and a coating layer including an inorganic material.

### Electrolyte ELL

The electrolyte ELL for a rechargeable lithium battery may include a non-aqueous organic solvent and a lithium salt.

The non-aqueous organic solvent may serve as a medium for transmitting ions that participate in an electrochemical reaction of a battery.

The non-aqueous organic solvent may include a carbonate-based solvent, an ester-based solvent, an ether-based solvent, a ketone-based solvent, an alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, or caprolactone.

The ether-based solvent may include dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The aprotic solvent may include nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolanes.

The non-aqueous organic solvent may be used alone or in a mixture of two or more substances.

In addition, if (e.g., when) a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be a material that is dissolved in the non-aqueous organic solvent to serve as a supply source of lithium ions in a battery and plays a role in enabling a basic operation of a rechargeable lithium battery and in promoting the movement of lithium ions between positive and negative electrodes. The lithium salt may include, for example, at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N, lithium bis(fluorosulfonyl)imide (LiFSI), LiC₄F₉SO₃, LiN(CₓF₂ₓ₊₁SO₂)(C_{y}F_{2y+1}SO₂) (where x and y are integers between 1 and 20), lithium trifluoromethane sulfonate, lithium tetrafluoroethanesulfonate, lithium difluorobis(oxalato)phosphate (LiDFOB), and lithium bis(oxalato) borate (LiBOB)

The following will describe in more detail an electrolyte for a rechargeable lithium battery according to one or more embodiments.

An electrolyte for a rechargeable lithium battery according to one or more embodiments of the present disclosure may include a non-aqueous organic solvent, a lithium salt, a first compound represented by Chemical Formula 1, and a second compound represented by Chemical Formula 2.

R^{1A}—O—R^{1B} [Chemical Formula 1]

In Chemical Formula 1, R^{1A} and R^{1B} may each independently be a substituted or unsubstituted C2 to C10 alkyl group.

In Chemical Formula 1, at least one selected from among R^{1A} and R^{1B} may be a halogenated alkyl group represented by Chemical Formula A1. In one or more embodiments, one of R^{1A} and R^{1B} may be a halogenated alkyl group represented by Chemical Formula A1, and the other of R^{1A} and R^{1B} may be a substituted or unsubstituted C2 to C10 alkyl group. In one or more embodiments, both (e.g., simultaneously) of R^{1A} and R^{1B} may be a halogenated alkyl group represented by Chemical Formula A1.

CₙH₂ₙ₊₁₋ₘXₘ [Chemical Formula A1]

In Chemical Formula A1, X may be F, Cl, Br, I, and/or a (e.g., any suitable) combination thereof.

In Chemical Formula A1, n may be an integer between 2 and 10.

In Chemical Formula A1, m may be an integer between 2 and 2n+1.

For example, X may be F.

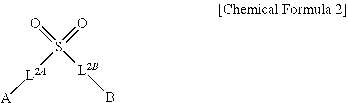

In Chemical Formula 2, L^{2A} and L^{2B} may each independently be a single bond, a substituted or unsubstituted C1 to C5 alkylene group, a substituted or unsubstituted C2 to C5 alkenylene group, a substituted or unsubstituted C2 to C5 alkynylene group, or a substituted or unsubstituted C6 to C20 arylene group. When L^{2A} is a single bond, A may be directly connected via a single bond to S. When L^{2B} is a single bond, B may be directly connected via a single bond to S.

In Chemical Formula 2, A and B may each independently be a substituted or unsubstituted C1 to C20 alkyl group, a substituted or unsubstituted C6 to C20 aryl group, or a substituted or unsubstituted C2 to C20 heteroaryl group.

In Chemical Formula 2, at least one selected from among A and B may be a group represented by Chemical Formula A2. In one or more embodiments, one of A and B may be a group represented by Chemical Formula A2, and the other of A and B may be a substituted or unsubstituted C1 to C20 alkyl group, a substituted or unsubstituted C6 to C20 aryl group, or a substituted or unsubstituted C2 to C20 heteroaryl group. In one or more embodiments, both (e.g., simultaneously) of A and B may be a group represented by Chemical Formula A2.

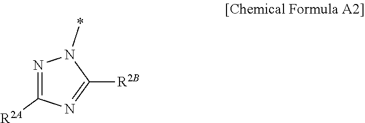

In Chemical Formula A2, R^{2A} and R^{2B} may each independently be hydrogen, halogen, a substituted or unsubstituted C1 to C10 alkyl group, or a substituted or unsubstituted C3 to C10 cycloalkyl group.

For example, the first compound may include 1,1,2,2-tetrafluoroethyl 2,2,2-trifluoroethyl ether, 1,1,2,2-tetrafluoroethyl 2,2,3,3-tetrafluoropropyl ether, and/or a (e.g., any suitable) mixture thereof.

For example, Chemical Formula 1 may be represented by Chemical Formula 1-1.

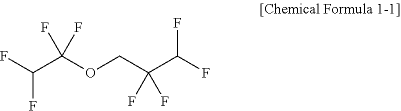 [SMILES: FC(F)C(F)(F)COC(F)(F)C(F)F]

### 1,1,2,2-tetrafluoroethyl 2,2,3,3-tetrafluoropropyl ether (CAS No.: 16627-68-2)

An increase in electrode mixture density may increase an energy density, but may relatively reduce impregnation characteristics of an electrolyte. A fluorine-based compound may improve the wettability of electrolyte and the adhesion of electrode and may reduce the surface tension of electrolyte.

The first compound may be added to an electrolyte for a rechargeable lithium battery to improve impregnation characteristics of the electrolyte. The first compound may improve impregnation of an electrolyte in a rechargeable lithium battery to which is applied an electrode whose mixture density is high.

The first compound may be included in an amount of about 0.1 wt % to about 20 wt % relative to the total weight of an electrolyte for a rechargeable lithium battery.

For example, the first compound may be included in an amount of about 0.1 wt % to about 15 wt %, about 0.1 wt % to about 10 wt %, about 1 wt % to about 10 wt %, or 5 wt % to about 10 wt % relative to the total weight of an electrolyte for a rechargeable lithium battery.

In a rechargeable lithium battery, a non-aqueous electrolyte may be decomposed during an initial charge-discharge to form a film having passivation ability on surfaces of positive and negative electrodes to improve high-temperature storage characteristics, but the film may be deteriorated due to acid such as HF⁻ and PF₅⁻ produced by thermal decomposition of lithium salts (LiPF₆ and/or the like) used in lithium ion batteries. This acid attack may elute transition metal elements from the positive electrode and increase a surface resistance of the electrode caused by a structural change of the surface, and a theoretical capacity may be reduced due to loss of metal elements which are redox (reduction and oxidation) centers, which may result in a reduction in capacity. In addition, the eluted transition metal ions may be electrodeposited on the negative electrode that reacts in a strong reduction potential range to not only consume electrons but also destruct the film during the electrodeposition to expose the surface of the negative electrode, thereby causing an additional electrolyte decomposition reaction. There may thus be an increase in resistance of the negative electrode and in irreversible capacity, and accordingly there may be a problem of substantially continuous reduction in cell capacity. In the present disclosure, a triazole group and a sulfone group of the compound represented by Chemical Formula 2 mentioned above may provide an unshared electron pair to capture PF₅⁻ and stabilize a LiPF₆ salt, with the result that it may be possible to remove the acid led by decomposition of the lithium salt.

The sulfone group included in Chemical Formula 2 may form a film on the surface of the positive electrode to suppress or reduce decomposition of a positive electrode active material, and thus it may be possible to inhibit or reduce gas generation and dissolution of transition metal due to the decomposition of the positive electrode active material.

In addition, the composition represented by Chemical Formula 2 mentioned above may strengthen a solid electrolyte interface (SEI) layer on the surface of the negative electrode, while preventing or reducing deterioration of the SEI layer or dissolution of transistor metals from the positive electrode during high-temperature storage.

For example, at least one selected from among L^{2A} and L^{2B} may be a substituted or unsubstituted C1 to C5 alkylene group.

For example, L^{2A} and L^{2B} may each independently be a substituted or unsubstituted C1 to C5 alkylene group.

For example, at least one selected from among L^{2A} and L^{2B} may be a substituted or unsubstituted C2 to C5 alkylene group.

For example, L^{2A} and L^{2B} may each independently be a substituted or unsubstituted C2 to C5 alkylene group.

For example, Chemical Formula 2 may be represented by Chemical Formula 2-1.

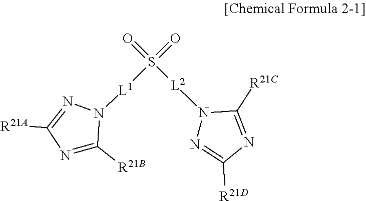

In Chemical Formula 2-1, L¹ and L² may each independently be a substituted or unsubstituted C2 to C5 alkylene group.

In Chemical Formula 2-1, R^{21A}, R^{21B}, R^{21C}, and R^{21D} may each independently be hydrogen, halogen, a substituted or unsubstituted C1 to C10 alkyl group, or a substituted or unsubstituted C3 to C10 cycloalkyl group.

In one or more embodiments, the second compound may be selected from among compounds listed in Group 1.

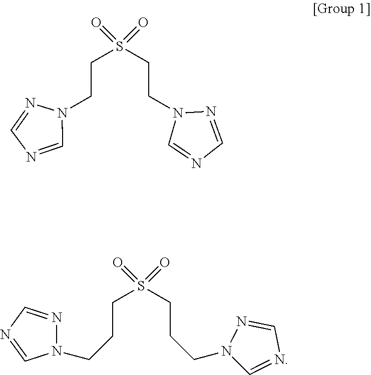 [SMILES: O=S(=O)(CCn1cncn1)CCn1cncn1 ; O=S(=O)(CCCn1cncn1)CCCn1cncn1]

The second compound may be included in an amount of about 0.1 wt % to about 10 wt % relative to the total weight of an electrolyte for a rechargeable lithium battery.

For example, the second compound may be included in an amount of about 0.5 wt % to about 10 wt %, about 1 wt % to about 10 wt %, or about 1 wt % to about 5 wt % relative to the total weight of an electrolyte for a rechargeable lithium battery.

The electrolyte for the rechargeable lithium battery may include the first compound and the second compound in a weight ratio of about 1:1 to about 20:1.

For example, the electrolyte for the rechargeable lithium battery may include the first compound and the second compound in a weight ratio of about 1:1 to about 15:1, about 1:1 to about 10:1, or about 5:1 to about 10:1.

When the first compound and the second compound are mixed in the ratio discussed above, the electrolyte may have the maximum degree of improvement in impregnation characteristics.

The first compound and the second compound may each be included in an amount of about 0.01 wt % to about 30 wt % relative to the total weight of the electrolyte for the rechargeable lithium battery.

For example, the first compound and the second compound may each be included in an amount of about 0.01 wt % to about 25 wt %, about 0.01 wt % to about 15 wt %, about 0.01 wt % to about 10 wt %, about 0.1 wt % to about 10 wt %, or about 1 wt % to about 10 wt % relative to the total weight of the electrolyte for the rechargeable lithium battery. When the content (e.g., amount) range is as described above, an increase in high-temperature resistance may be prevented or reduced to achieve a rechargeable lithium battery with improved lifetime and output characteristics.

The electrolyte of a rechargeable lithium battery may further include at least one selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propenesultone (PST), propanesultone (PS), lithium tetrafluoroborate (LiBF₄), lithium difluorophosphate (LiPO₂F₂), and 2-fluoro biphenyl (2-FBP).

The additional inclusion of the aforementioned other additives may further increase the lifetime or effectively control gas generation from the positive and negative electrodes during high-temperature storage.

The other additive may be included in an amount of about 0.1 wt % to about 20 wt %, about 0.2 wt % to about 15 wt %, or about 0.2 wt % to about 190 wt % relative to the total weight of the electrolyte for the rechargeable lithium battery.

When the amount of the additive is described above, an increase in film resistance may be minimized or reduced to contribute to an improvement in battery performance.

### Rechargeable Lithium Battery

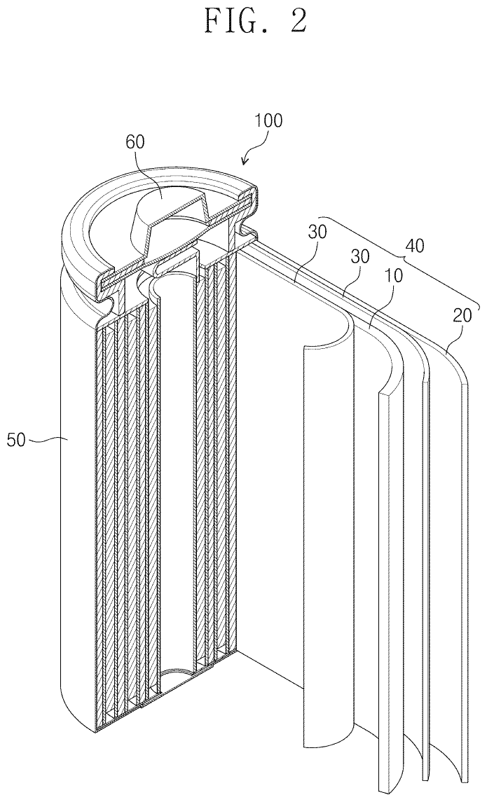

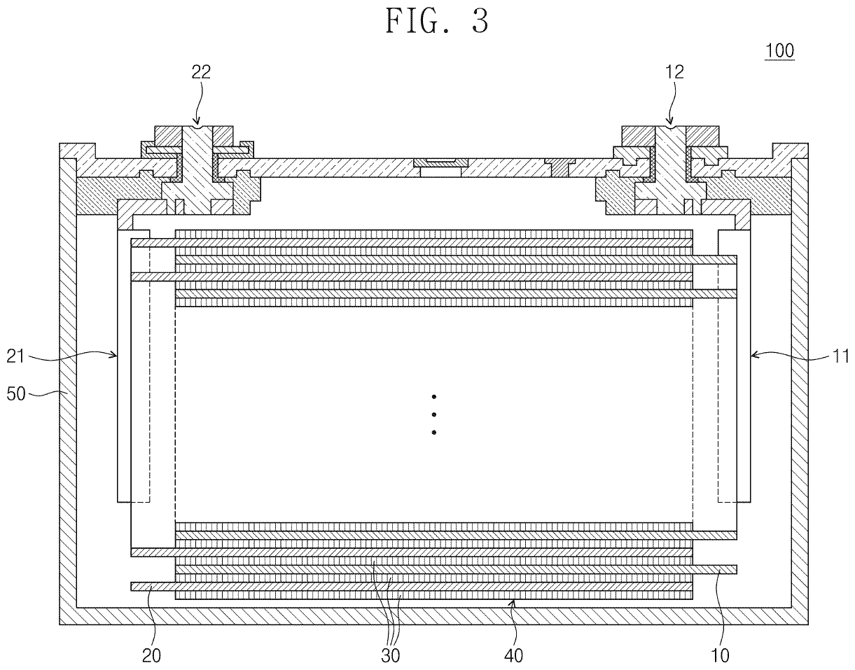

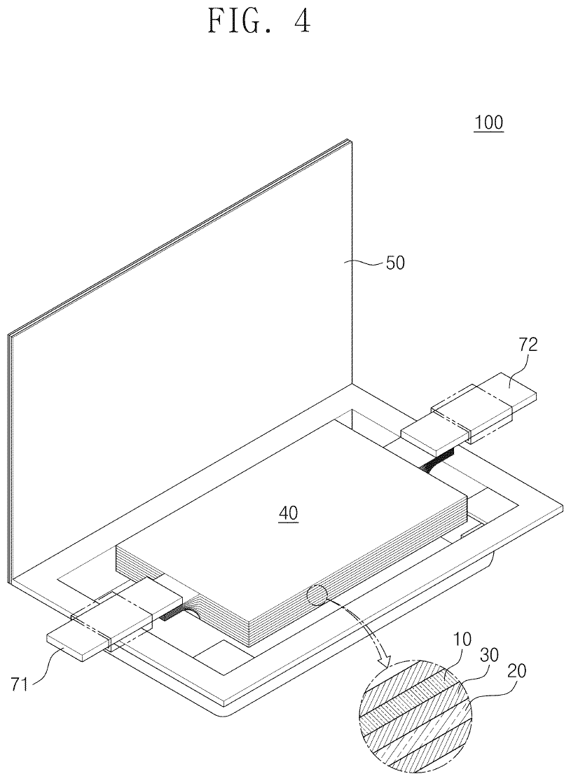

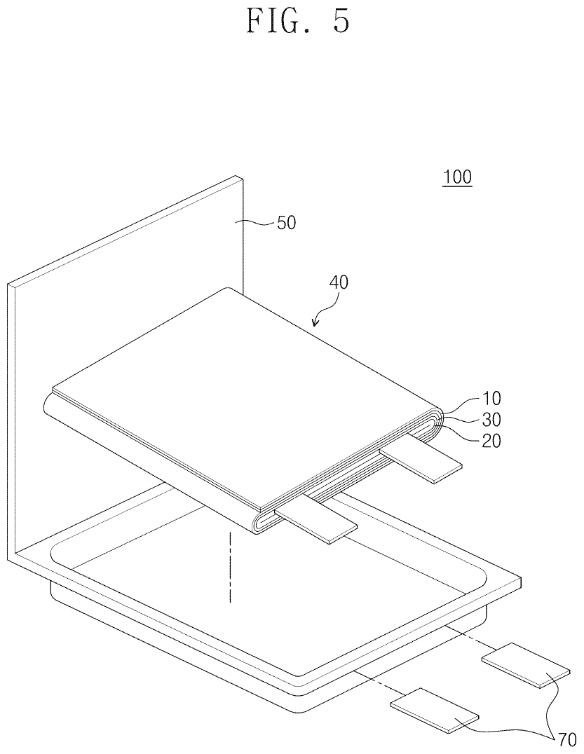

Based on shape of a rechargeable lithium battery, the rechargeable lithium battery may be classified into cylindrical, prismatic, pouch, and coin types (kinds). In FIGS. 2 to 5 illustrating diagrams showing a rechargeable lithium battery according to one or more embodiments, FIG. 2 shows a cylindrical battery, FIG. 3 shows a prismatic battery, and FIGS. 4 and 5 show pouch-type or kind batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte. The rechargeable lithium battery 100 may include a sealing member 60 that seals the casing 50 as illustrated in FIG. 2. In addition, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70, or a positive electrode tab 71 and a negative electrode tab 72, which electrode tab 70 serves as an electrical path for externally inducing a current generated in the electrode assembly 40.

A rechargeable lithium battery according to one or more embodiments of the present disclosure may be applied to automotive vehicles, mobile phones, and/or any other electrical devices, but the present disclosure is not limited thereto.

The following will describe Embodiments and Comparative Examples of the present disclosure. The following example is only one or more embodiments of the present disclosure, and the present disclosure is not limited to the following example.

### EMBODIMENTS AND COMPARATIVE EXAMPLES

An electrolyte and a rechargeable lithium battery were manufactured by the following method.

### Embodiment 1

### (1) Preparation of Electrolyte

1.3 M LiPF₆ was dissolved in a non-aqueous organic solvent in which ethylene carbonate (EC), propylene carbonate (PC), ethylpropyl carbonate (EPC), and propyl propionate (PP) are mixed in a volume ratio of 10:15:30:45, and an electrolyte was prepared by adding a first compound represented by Chemical Formula 1-1 and a second compound represented by Chemical Formula 2-1-1.

The first compound was mixed at 5 wt % relative to the total 100 wt % of the electrolyte, and the second compound was mixed at 1 wt % relative to the total 100 wt % of the electrolyte.

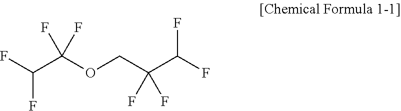 [SMILES: FC(F)C(F)(F)COC(F)(F)C(F)F]

### 1,1,2,2-tetrafluoroethyl 2,2,3,3-tetrafluoropropyl ether (CAS No.: 16627-68-2)

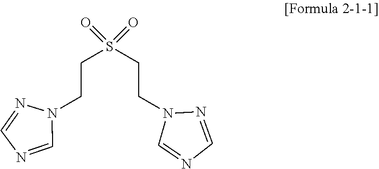 [SMILES: O=S(=O)(CCn1cncn1)CCn1cncn1]

### (2) Fabrication of Rechargeable Lithium Battery

LiCoO₂ as a positive electrode active material, polyvinylidene fluoride as a binder, and acetal black as a conductive material were mixed in a weight ratio of 96:3:1, and the mixture was distributed in n-methyl pyrrolidone to prepare a positive electrode active material slurry.

The positive electrode active material slurry was coated on an Al foil of 15 μm in thickness, dried at a temperature of 100° C., and then pressed to manufacture a positive electrode.

Artificial graphite as a negative electrode active material, a styrene-butadiene rubber binder, and carboxymethyl cellulose were mixed in a weight ratio of 98:1:1, and dispersed in distilled water to prepare a negative electrode active material slurry.

The negative electrode active material slurry was coated on a Cu foil of 10 μm in thickness, dried at 100° C., and then pressed to manufacture a negative electrode. In this step (e.g., act or task), the negative electrode was adjusted to have a mixture density of 1.7 g/cc.

The positive electrode, the negative electrode, and a polyethylene separator of 10 μm in thickness were assembled to manufacture an electrode assembly, and the electrolyte was introduced to fabricate a rechargeable lithium battery.

### Embodiment 2

An electrolyte and a rechargeable lithium battery were manufactured by the same method as that of Embodiment 1, except that the first compound of 10 wt % and the second compound of 1 wt % were added if (e.g., when) the electrolyte was prepared.

### Embodiment 3

An electrolyte and a rechargeable lithium battery were manufactured by the same method as that of Embodiment 1, except that the first compound of 10 wt % and the second compound of 2 wt % were added if (e.g., when) the electrolyte was prepared.

### Embodiment 4

A rechargeable lithium battery was manufactured by the same method as that of Embodiment 3, except that a negative electrode was adjusted to have a mixture density of 1.75 g/cc if (e.g., when) the negative electrode was formed.

### Embodiment 5

A rechargeable lithium battery was manufactured by the same method as that of Embodiment 3, except that a negative electrode was adjusted to have a mixture density of 1.8 g/cc if (e.g., when) the negative electrode was formed.

### Comparative Example 1

An electrolyte and a rechargeable lithium battery were manufactured by the same method as that of Embodiment 1, except that neither the first compound nor the second compound was added if (e.g., when) the electrolyte was prepared, and that a negative electrode was adjusted to have a mixture density of 1.65 g/cc if (e.g., when) the negative electrode was formed.

### Comparative Example 2

An electrolyte and a rechargeable lithium battery were manufactured by the same method as that of Embodiment 1, except that neither the first compound nor the second compound was added if (e.g., when) the electrolyte was prepared, and that a negative electrode was adjusted to have a mixture density of 1.67 g/cc if (e.g., when) the negative electrode was formed.

### Comparative Example 3

An electrolyte and a rechargeable lithium battery were manufactured by the same method as that of Embodiment 1, except that neither the first compound nor the second compound was added if (e.g., when) the electrolyte was prepared.

### Comparative Example 4

An electrolyte and a rechargeable lithium battery were manufactured by the same method as that of Embodiment 1, except that the first compound of 5 wt % was added and the second compound was not added if (e.g., when) the electrolyte was prepared.

### Comparative Example 5

An electrolyte and a rechargeable lithium battery were manufactured by the same method as that of Embodiment 1, except that the second compound of 1 wt % was added and the first compound was not added if (e.g., when) the electrolyte was prepared.

### Evaluation Example

The following method was employed to evaluate a negative electrode and a rechargeable lithium battery.

Evaluation 1: Impregnation of Electrolyte into Negative Electrode

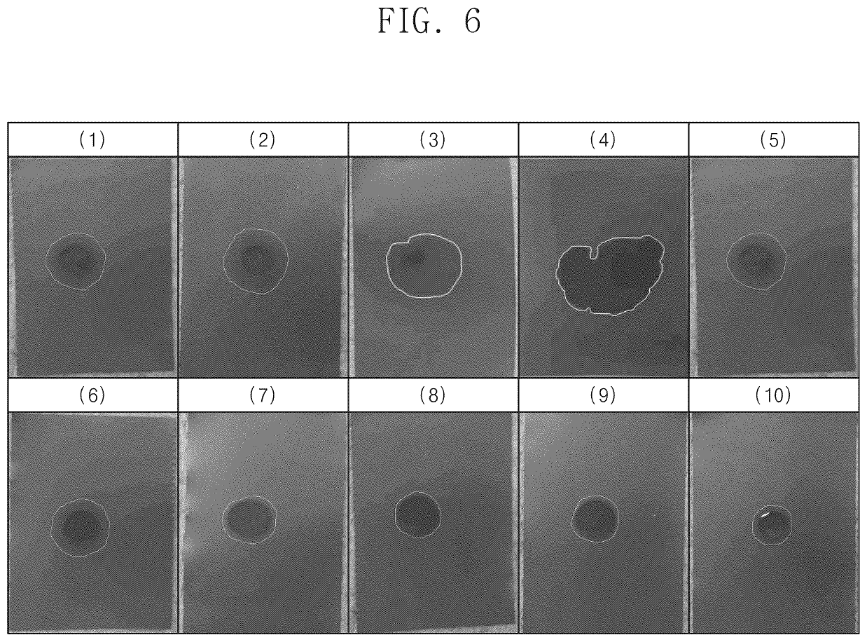

The negative electrode according to Embodiment 1 was manufactured as a specimen of 3 cm in width and 4 cm in length. 1 gram of the electrolyte according to Embodiment 1 was dropped on the specimen, and after a standing time of 1 minute, an image showing an area of the electrolyte on a surface of the negative electrode was captured and shown in FIG. 6.

In addition, among 100 wt % of the electrolyte dropped on the specimen, an amount of the electrolyte immersed in the specimen was evaluated as a numerical value from 0 to 5 according to the following criteria, and evaluation results were listed in Table 1.

0: An amount of the electrolyte immersed in the specimen is equal to or greater than 0 wt % and less than 10 wt %.

1: Amount of the electrolyte immersed in the specimen is equal to or greater than 10 wt % and less than 20 wt %.

2: Amount of the electrolyte immersed in the specimen is equal to or greater than 20 wt % and less than 40 wt %.

3: Amount of the electrolyte immersed in the specimen is equal to or greater than 40 wt % and less than 60 wt %.

4: Amount of the electrolyte immersed in the specimen is equal to or greater than 60 wt % and less than 80 wt %.

5: Amount of the electrolyte immersed in the specimen is equal to or greater than 80 wt % and less than 100 wt %.

The same method was used to evaluate Embodiments 2 to 5 and Comparative Examples 1 to 5, and evaluation results were listed in Table 1.

For reference, section (1) in FIG. 6 depicts an image obtained after a standing time of 1 minute according to Evaluation 1 by using the electrolyte of Embodiment 1.

Section (2) in FIG. 6 depicts an image obtained after a standing time of 1 minute according to Evaluation 1 by using the electrolyte of Embodiment 2.

Section (3) in FIG. 6 depicts an image obtained after a standing time of 1 minute according to Evaluation 1 by using the electrolyte of Embodiment 3.

Section (4) in FIG. 6 depicts an image obtained after a standing time of 1 minute according to Evaluation 1 by using the electrolyte of Embodiment 4.

Section (5) in FIG. 6 depicts an image obtained after a standing time of 1 minute according to Evaluation 1 by using the electrolyte of Embodiment 5.

For reference, section (6) in FIG. 6 depicts an image obtained after a standing time of 1 minute according to Evaluation 1 by using the electrolyte of Comparative Example 1.

For reference, section (6) in FIG. 7 depicts an image obtained after a standing time of 1 minute according to Evaluation 1 by using the electrolyte of Comparative Example 2.

Section (8) in FIG. 6 depicts an image obtained after a standing time of 1 minute according to Evaluation 1 by using the electrolyte of Comparative Example 3.

Section (9) in FIG. 6 depicts an image obtained after a standing time of 1 minute according to Evaluation 1 by using the electrolyte of Comparative Example 4.

Section (10) in FIG. 6 depicts an image obtained after a standing time of 1 minute according to Evaluation 1 by using the electrolyte of Comparative Example 5.

TABLE 1

| | Mixture | | | |
|---|---|---|---|---|
| | density of | | | Impregnation |
| | negative | First | Second | of electrolyte |
| | electrode | compound | compound | into negative |
| | (g/cc) | (wt %)* | (wt %) | electrode |
| Embodiment 1 | 1.7 | 5 | 1 | 3 |
| Embodiment 2 | 1.7 | 10 | 1 | 4 |
| Embodiment 3 | 1.7 | 10 | 2 | 5 |
| Embodiment 4 | 1.75 | 10 | 2 | 5 |
| Embodiment 5 | 1.8 | 10 | 2 | 4 |
| Comparative | 1.65 | —** | — | 3 |
| Example 1 | | | | |
| Comparative | 1.67 | — | — | 2 |
| Example 2 | | | | |
| Comparative | 1.7 | — | — | 1 |
| Example 3 | | | | |
| Comparative | 1.7 | 5 | — | 2 |
| Example 4 | | | | |
| Comparative | 1.7 | — | 1 | 1 |
| Example 5 | | | | |

*The unit wt % of the first compound and the second compound is based on the total 100 wt % of the electrolyte.
**The mark of hyphen (—) refers to no addition during the preparation of the electrolyte.

### Evaluation 2: Charge/Discharge Characteristics at High Temperature

The rechargeable lithium battery charged and discharged at 45° C. for 200 cycles under the condition of 0.33C charge (CC/CV, 4.3V, 0.025C Cut-off) and 1.0C discharge (CC, 2.5V Cut-off).

A thickness increase rate was calculated according to Equation 1, and a capacity retention rate was calculated according to Equation 2, and results were listed in Table 2.

$$[ Equation 1 ]$$

$$Thickness increase rate = 100 \times \{ ( full charge thickness after 200 cycles ) - ( full charge thickness after 1 cycle ) \} / ( full charge thickness after 1 cycle )$$

In Equation 1, the term “full charge thickness” may refer to a thickness of a rechargeable lithium battery measured after being charged to SOC 100% (a 100% fully charged state if (e.g., when) the total charge capacity of a battery is set to 100%) after each cycle.

$$[ Equation 2 ]$$

$$Capacity retention rate = ( discharge capacity after 200 cycles / discharge capacity after 1 cycle ) \times 100$$

TABLE 2

| | | | | Charge/discharge | |
|---|---|---|---|---|---|
| | | | | characteristics at room | |
| | | | | temperature of | |
| | Mixture | | | rechargeable lithium | |
| | density of | | | battery | |
| | negative | First | Second | Thickness | Capacity |
| | electrode | compound | compound | increase | retention |
| | (g/cc) | (wt %)* | (wt %) | rate (%) | rate (%) |
| Embodiment 1 | 1.7 | 5 | 1 | 14.3 | 88 |
| Embodiment 2 | 1.7 | 10 | 1 | 10.2 | 90 |
| Embodiment 3 | 1.7 | 10 | 2 | 7.9 | 92 |
| Embodiment 4 | 1.75 | 10 | 2 | 9.2 | 93 |
| Embodiment 5 | 1.8 | 10 | 2 | 10.9 | 91 |
| Comparative | 1.65 | —** | — | 16.7 | 85 |
| Example 1 | | | | | |
| Comparative | 1.67 | — | — | 18.2 | 77 |
| Example 2 | | | | | |
| Comparative | 1.7 | — | — | 20.1 | 75 |
| Example 3 | | | | | |
| Comparative | 1.7 | 5 | — | 21.6 | 69 |
| Example 4 | | | | | |
| Comparative | | | | | |
| Example 5 | 1.7 | — | 1 | 23.4 | 66 |

*The unit wt % of the first compound and the second compound is based on the total 100 wt % of the electrolyte.
**The mark of hyphen (—) refers to no addition during the preparation of the electrolyte.

### Comprehensive Evaluation

Referring to Tables 1 and 3 and FIGS. 6 to 15, in the cases (Comparative Examples 1 to 3) where neither the first compound nor the second compound was used, as the mixture density of the negative electrodes increases from 1.65 g/cc to 1.7 g/cc, there may be a reduction in impregnation of the electrolyte into the negative electrode, an increase in battery thickness, and a decrease in lifetime.

When the negative electrode has the same mixture density of 1.7 g/cc, compared with the cases (Comparative Examples 3 to 5) using an electrolyte including none or only one of the first compound and the second compound, the cases (Embodiments 1 to 3) each using an electrolyte including the first compound and the second compound may have an increase in impregnation of the electrolyte into the negative electrode, a reduction in battery thickness, and an increase in lifetime.

In the case using an electrolyte including a compound in which the first compound and the second compound are mixed with each other, it may be possible to suppress or reduce an increase in battery thickness and a reduction in lifetime even if (e.g., when) the mixture density of the negative electrode increases from 1.7 g/cc to 1.8 g/cc (Embodiments 4 and 5).

An electrolyte for a rechargeable lithium battery according to one or more embodiments may improve in impregnation, high-temperature lifetime, and electrode swelling.

A battery management system (BMS) device, and/or any other relevant devices or components according to embodiments of the present disclosure described herein may be implemented utilizing any suitable hardware, firmware (e.g. an application-specific integrated circuit), software, or a combination of software, firmware, and hardware. For example, the one or more suitable components of the device may be formed on one integrated circuit (IC) chip or on separate IC chips. Further, the one or more suitable components of the device may be implemented on a flexible printed circuit film, a tape carrier package (TCP), a printed circuit board (PCB), or formed on one substrate. Further, the one or more suitable components of the device may be a process or thread, running on one or more processors, in one or more computing devices, executing computer program instructions and interacting with other system components for performing the one or more suitable functionalities described herein. The computer program instructions are stored in a memory which may be implemented in a computing device utilizing a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of one or more suitable computing devices may be combined or integrated into a single computing device, or the functionality of a particular computing device may be distributed across one or more other computing devices without departing from the scope of the present disclosure.

While this disclosure has been described in connection with what is presently considered to be example embodiments, it is to be understood that the present disclosure is not limited to the disclosed embodiments and is intended to cover one or more suitable modifications and equivalent arrangements included within the spirit and scope of the appended claims, equivalents thereof, and therefore the aforementioned embodiments should be understood to be exemplarily but not limiting this disclosure in any way.

What is claimed is:

1. An electrolyte comprising:
a non-aqueous organic solvent;
a lithium salt;
a first compound represented by Chemical Formula 1; and
a second compound represented by Chemical Formula 2,
R^{1A}—O—R^{1B}, [Chemical Formula 1]
wherein in Chemical Formula 1,
R^{1A} and R^{1B} are each independently a substituted or unsubstituted C2 to C10 alkyl group, and
at least one selected from among R^{1A} and R^{1B} is a halogenated alkyl group represented by Chemical Formula A1,
CₙH₂ₙ₊₁₋ₘXₘ, [Chemical Formula A1]
wherein in Chemical Formula A1,
X is F, Cl, Br, I, or a combination thereof,
n is an integer between 2 and 10, and
m is an integer between 2 and 2n+1, 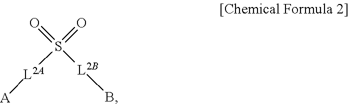
wherein in Chemical Formula 2,
L^{2A} and L^{2B} are each independently a single bond, a substituted or unsubstituted C1 to C5 alkylene group, a substituted or unsubstituted C2 to C5 alkenylene group, a substituted or unsubstituted C2 to C5 alkynylene group, or a substituted or unsubstituted C6 to C20 arylene group,
A and B are each independently a substituted or unsubstituted C1 to C20 alkyl group, a substituted or unsubstituted C6 to C20 aryl group, or a substituted or unsubstituted C2 to C20 heteroaryl group, and
at least one selected from among A and B is a group represented by Chemical Formula A2, 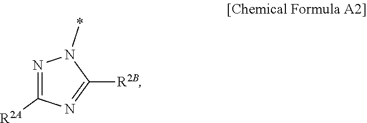
wherein in Chemical Formula A2, R^{2A} and R^{2B} are each independently hydrogen, halogen, a substituted or unsubstituted C1 to C10 alkyl group, or a substituted or unsubstituted C3 to C10 cycloalkyl group, and
wherein the electrolyte is for a rechargeable lithium battery.

2. The electrolyte as claimed in claim 1, wherein R^{1A} and R^{1B} are each independently a halogenated alkyl group represented by Chemical A1.

3. The electrolyte as claimed in claim 1, wherein X is F.

4. The electrolyte as claimed in claim 1, wherein the first compound comprises 1,1,2,2-tetrafluoroethyl 2,2,2-trifluoroethyl ether, 1,1,2,2-tetrafluoroethyl 2,2,3,3-tetrafluoropropyl ether, or a mixture thereof.

5. The electrolyte as claimed in claim 1, wherein Chemical Formula 1 is represented by Chemical Formula 1-1,

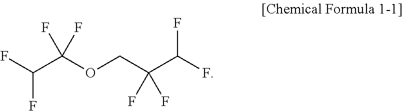 [SMILES: FC(F)C(F)(F)COC(F)(F)C(F)F]

6. The electrolyte as claimed in claim 1, wherein at least one selected from among L^{2A} and L^{2B} is a substituted or unsubstituted C1 to C5 alkylene group.

7. The electrolyte as claimed in claim 1, wherein at least one selected from among L^{2A} and L^{2B} is a substituted or unsubstituted C2 to C5 alkylene group.

8. The electrolyte as claimed in claim 1, wherein L^{2A} and L^{2B} are each independently a substituted or unsubstituted C2 to C5 alkylene group.

9. The electrolyte as claimed in claim 1, wherein Chemical Formula 2 is represented by Chemical Formula 2-1, 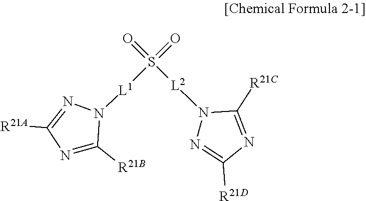
wherein in Chemical Formula 2-1,
L¹ and L² are each independently a substituted or unsubstituted C2 to C5 alkylene group, and
R^{21A}, R^{21B}, R^{21C}, and R^{21D} are each independently hydrogen, halogen, a substituted or unsubstituted C1 to C10 alkyl group, or a substituted or unsubstituted C3 to C10 cycloalkyl group.

10. The electrolyte as claimed in claim 1, wherein the second compound comprises at least one selected from among compounds listed in Group 1,

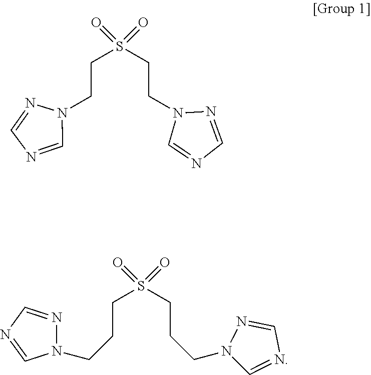 [SMILES: O=S(=O)(CCn1cncn1)CCn1cncn1 ; O=S(=O)(CCCn1cncn1)CCCn1cncn1]

11. The electrolyte as claimed in claim 1, wherein the first compound and the second compound are in a weight ratio of about 1:1 to about 20:1.

12. The electrolyte as claimed in claim 1, wherein the first compound and the second compound are in a weight ratio of about 5:1 to about 10:1.

13. The electrolyte as claimed in claim 1, wherein the first compound is in an amount of about 0.1 wt % to about 20 wt % relative to a total weight of the electrolyte for the rechargeable lithium battery.

14. The electrolyte as claimed in claim 1, wherein the second compound is in an amount of about 0.1 wt % to about 10 wt % relative to a total weight of the electrolyte for the rechargeable lithium battery.

15. The electrolyte as claimed in claim 1, further comprising at least one selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propenesultone (PST), propanesultone (PS), lithium tetrafluoroborate (LiBF₄), lithium difluorophosphate (LiPO₂F₂), and 2-fluoro biphenyl (2-FBP).

16. A rechargeable lithium battery comprising:
a positive electrode that comprises a positive electrode active material;
a negative electrode that comprises a negative electrode active material; and
the electrolyte for the rechargeable lithium battery as claimed in claim 1.

17. The rechargeable lithium battery as claimed in claim 16, wherein the negative electrode has a mixture density of equal to or greater than about 1.7 g/cc.
